(19) United States
(12) Patent Application Publication
(10) Pub. No.: US 2013/0044465 A1
(43) Pub. Date: Feb. 21, 2013

(54) METHOD AND APPARATUS FOR PROVIDING USER INPUT

(71) Applicants: Zhongkui Chen, Beijing (CN); Kongqiao Wang, Helsinki (FI); Anping Zhao, Beijing (CN); Liangfeng Xu, Beijing (CN)

(72) Inventors: Zhongkui Chen, Beijing (CN); Kongqiao Wang, Helsinki (FI); Anping Zhao, Beijing (CN); Liangfeng Xu, Beijing (CN)

(73) Assignee: NOKIA CORPORATION, Espoo (FI)

(21) Appl. No.: 13/643,758

(22) PCT Filed: Apr. 30, 2010
(86) PCT No.: PCT/CN10/00613

§ 371 Date: Oct. 26, 2012

(51) Int. Cl. F21L 4/00

(52) U.S. Cl. 362/103; 362/186

(57) ABSTRACT

According to an embodiment of the present invention, an apparatus comprises an elongated body portion having an interior chamber and a tapered end; a transparent dome housing accommodated by the tapered end; a light source housed within the transparent dome housing and capable of emitting light through the transparent dome housing to an external receiver; a battery housed within the interior chamber and electrically coupled with the light source; and a surface detection mechanism coupled with the transparent dome housing and electrically coupled with the light source and the battery, the surface detection mechanism capable of at least one of activating the light source when the apparatus contacts a surface and deactivating the light source when the apparatus does not contact the surface.

### TECHNICAL FIELD

The present application relates generally to a method and apparatus for providing user input.

### BACKGROUND

Many electronic devices on the market today such as mobile phones include embedded digital camera technology. A digital camera embedded on an electronic device along with image processing and gesture recognition technology may enable recognition of a user's hand or finger gestures. Providing alternative data input techniques utilizing digital cameras on electronic devices may provide for a more robust user interface.

### SUMMARY

Various aspects of examples of the invention are set out in the claims. According to a first aspect of the present invention, an apparatus comprises an elongated body portion having an interior chamber and a tapered end; a transparent dome housing accommodated by the tapered end; a light source housed within the transparent dome housing and capable of emitting light through the transparent dome housing to an external receiver; a battery housed within the interior chamber and electrically coupled with the light source; and a surface detection mechanism coupled with the transparent dome housing and electrically coupled with the light source and the battery, the surface detection mechanism capable of at least one of activating the light source when the apparatus contacts a surface and deactivating the light source when the apparatus does not contact the surface.

According to a second aspect of the present invention, an apparatus comprises a circular body portion having an interior chamber and capable of being worn on a finger of a user; a light source coupled with the circular body portion capable of emitting light to an external receiver; a battery housed within the interior chamber and electrically coupled with the light source; and a surface detection mechanism coupled with the circular body portion and electrically coupled with the light source and the battery, the surface detection mechanism capable of at least one of activating the light source when the apparatus contacts a surface and deactivating the light source when the apparatus does not contact the surface.

According to a third aspect of the present invention, an apparatus comprises a first and second circular body portions having at least one interior chamber and capable of being worn on two fingers of a user; a light source coupled with at least one of the first and second circular body portions capable of emitting light to an external receiver; a battery housed within the interior chamber and electrically coupled with the light source; and at least one surface detection mechanism coupled with at least one of the first and second circular body portions and electrically coupled with the light source and the battery, the at least one surface detection mechanism capable of at least one of activating the light source when the apparatus contacts a surface and deactivating the light source when the apparatus does not contact the surface.

According to a fourth aspect of the present invention, a method comprises activating a surface detection mechanism by making contact with a writing surface, the surface detection mechanism being coupled with a circular body portion and electrically coupled with a light source and a battery, the activation causing the light source to emit light.

### BRIEF DESCRIPTION OF THE DRAWINGS

For a more complete understanding of example embodiments of the present invention, reference is now made to the following descriptions taken in connection with the accompanying drawings in which:

FIG. 1 is a diagram of a system for providing user input according to an example embodiment of the invention;

FIG. 2 is a diagram of an apparatus having a body portion according to an example embodiment of the invention;

FIG. 3a is a diagram of a tapered end of an apparatus having an elongated body portion according to an example embodiment of the invention;

FIG. 3b is a sectional diagram of a film switch according to an example embodiment of the invention;

FIG. 4 is a diagram of an apparatus having a circular body portion according to an example embodiment of the invention;

FIG. 5 is a diagram of an apparatus having a plurality of circular body portions according to an example embodiment of the invention;

FIG. 6 is a block diagram of an apparatus according to an example embodiment of the invention;

FIG. 7 is a flow diagram illustrating an example method for providing user input according to an example embodiment of the invention;

FIG. 8 is a diagram of an apparatus comprising a finger sleeve 815 according to an example embodiment of the invention; and

FIG. 9 is a diagram of an apparatus comprising a hollow transparent dome housing according to an embodiment of the invention.

### DETAILED DESCRIPTION OF THE DRAWINGS

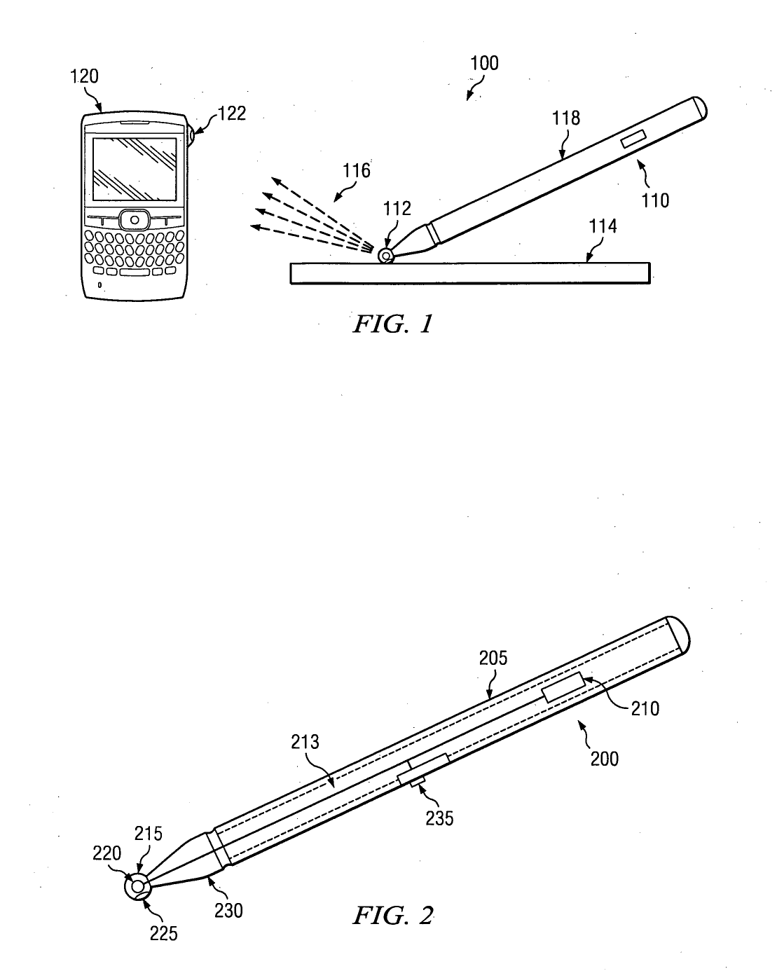

An example embodiment of the present invention and its potential advantages are understood by referring to FIGS. 1 through 9 of the drawings.

FIG. 1 is a diagram of a system for providing user input according to an example embodiment of the invention. In an embodiment, a system for providing user input such as system 100 comprises an electronic device 120 and an apparatus 110. In an embodiment, electronic device 120 may be any type of electronic device with an embedded camera such as but not limited to a mobile communications device, personal digital assistant and/or the like.

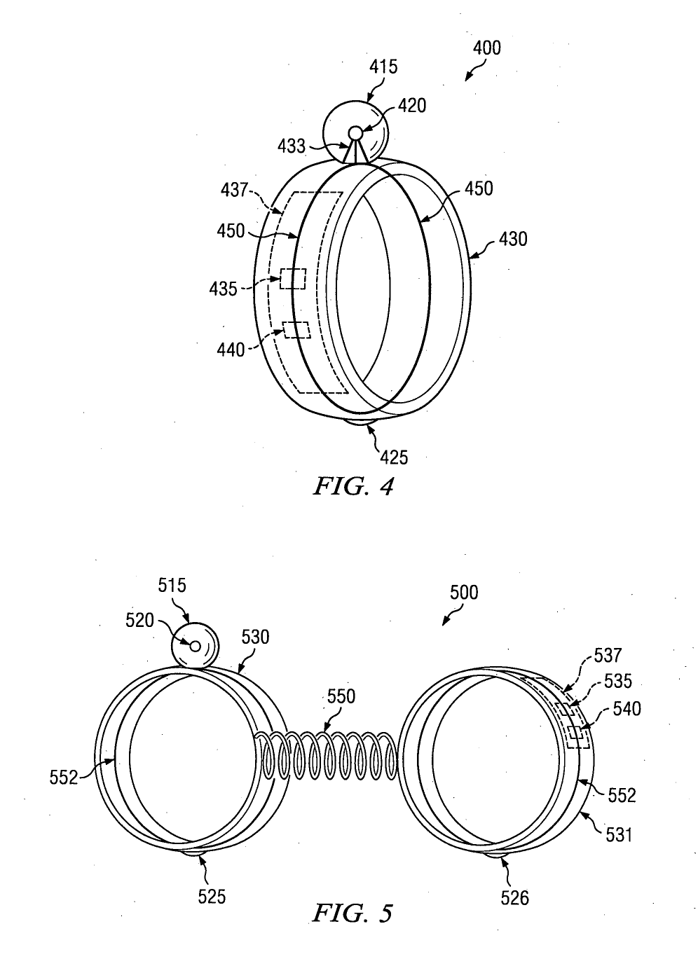

In an embodiment, apparatus 110 comprises a body portion such as elongated body portion 118, a dome housing 112 and a surface detection mechanism such as surface detection mechanism 225 as shown in FIG. 2. In an embodiment, apparatus 110 further comprises a light source (not shown) embedded within the dome housing 112. In an embodiment, the light source is capable of emitting light in at least one color. A body portion may have any physical configuration including but not limited to an elongated configuration, such as apparatus 110, at least one circular configuration such as apparatus 400 of FIG. 4, apparatus 500 of FIG. 5 and/or the like. A surface detection mechanism may detect whether apparatus 110 is making contact with a surface such as writing surface 114 in any manner.

In an embodiment, when apparatus 110 makes contact with a surface such as surface 114, surface detection mechanism 114 causes the light source to emit light. Light such as the light 116 as depicted in FIG. 1 is received by a digital camera such as digital camera 122 on electronic device 120. In an embodiment, image processing technology embedded within electronic device 120 detects light 116 from the light source and tracks movement of the dome housing 112 along writing surface 114. Further, in an embodiment, image processing technology embedded within electronic device 120 is capable of differentiating among a plurality of colors emitted by the light source. In an embodiment, gesture recognition technology embedded within electronic device 120 is capable of determining particular gestures performed by apparatus 110. In an embodiment, based at least in part on particular gestures as determined by the embedded gesture recognition technology and/or the at least one color of light emitted by light source, electronic device 120 is capable of performing a function such as displaying a representation of the gesture on a display, tracking a cursor on a display, activating a feature on the electronic device 120 and/or the like.

In an embodiment, apparatus 110 operates as a computer mouse. In an embodiment, a computer mouse is a hand-operated electronic device that controls the coordinates of a cursor on a screen of another electronic device such as electronic device 120.

FIG. 2 is a diagram of an apparatus 200 having a body portion according to an example embodiment of the invention. In an embodiment, apparatus 200 comprises a body portion such as elongated body portion 205 having an interior chamber 213 and a tapered end 230. Interior chamber 213 may reside at any position within elongated body portion 205. Further, interior chamber 213 may be of any size to sufficiently house a battery such as battery 210. In an embodiment, apparatus 200 further comprises a dome housing such as transparent dome housing 215 accommodated by the tapered end 230 of apparatus 200.

In an embodiment, apparatus 200 further comprises a light source 220 housed within the dome housing. The light source 220 may be of any type including but not limited to a light emitting diode, other electroluminescent materials such as liquid crystal, and/or the like. In an embodiment, the light source 220 is capable of emitting light through the transparent dome housing to an external receiver such as a digital camera. In an embodiment, the light source 220 is able to emit light of at least one color including but not limited to red, green and blue.

In an embodiment, apparatus 200 further comprises a battery such as battery 210 housed within interior chamber 213 and electrically coupled with light source 220. Battery 210 may have any capacity sufficient to power light source 220.

In an embodiment, apparatus 200 further comprises a surface detection mechanism such as surface detection mechanism 225 coupled with the transparent dome housing. In an embodiment, surface detection mechanism is electrically coupled with light source 220 and battery 210. In an embodiment, the surface detection mechanism is capable of activating the light source when the apparatus is in contact with a surface such as writing surface 114 of FIG. 1. Further, in an embodiment, the surface detection mechanism is capable of deactivating the light source when the apparatus is not in contact with a surface. A surface detection mechanism may detect whether apparatus 200 is making contact with the writing surface 114 of FIG. 1 in any manner. In an embodiment, the surface detection mechanism is a mechanical switch such as a film switch, which is capable of activating a light source when the apparatus 200 contacts a surface such as writing surface 114 of FIG. 1. In an embodiment, the surface detection mechanism is capable of deactivating the light source when the apparatus 200 does not contact a surface. In an embodiment, apparatus 200 is a computer mouse. In an embodiment, apparatus 200 is the apparatus 110 of FIG. 1.

In an embodiment, apparatus 200 further comprises a switch such as switch 235 coupled with elongated body portion 205. Switch 235 may be any type of switch including but not limited to a toggle switch. Further, in an embodiment, switch 235 is electrically coupled with battery 210, light source 220 and surface detection mechanism 225 with wires such as wires 213. However, any conducting material may be used. In an embodiment, switch 235 is configured to cause light source 220 to emit a particular color of light when switch 235 is in at least one position and apparatus 200 makes contact with a surface. In an embodiment, light source 220 is a multicolored light emitting diode configured to emit a different color for each position of switch 235 when apparatus 200 makes contact with a writing surface.

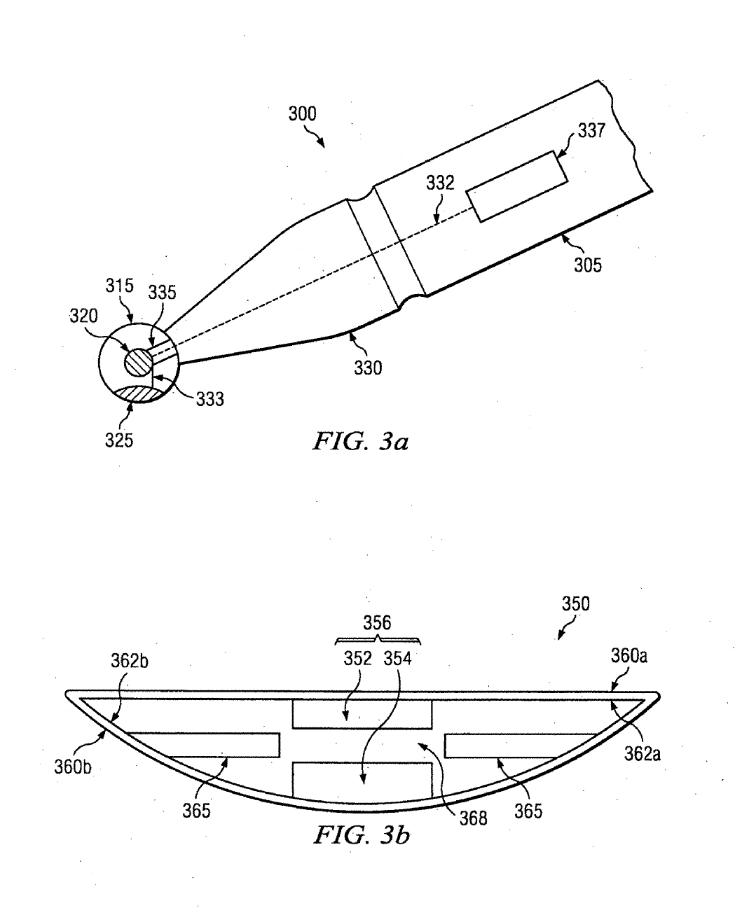

FIG. 3a is a diagram of a tapered end of an apparatus such as apparatus 300 having an elongated body portion 305 according to an example embodiment of the invention. In an embodiment, apparatus 300 comprises an elongated body portion 300 and a dome housing such as dome housing 315 coupled with a tapered end of an apparatus such as tapered end 330. In an embodiment, apparatus 300 further comprises a light source such as light source 320 housed within the dome housing. In an embodiment, light source 320 is a light emitting diode. However, light source 320 may be any type of light source, which is capable of emitting light through a transparent dome housing to a receiver such as digital camera 122 of electronic device 120 both of FIG. 1. In an embodiment, light source 320 is coupled with a light source holder 335 and a surface detection mechanism such as surface detection mechanism 325.

In an embodiment, apparatus 300 further comprises a battery such as battery 337 for powering the light source. In an embodiment, light source 320 is electrically connected with a battery 337 and surface detection mechanism 325 with wires such as wires 332 and 333. However, any conducting material may connect light source 320 with battery 337 and surface detection mechanism 325.

In an embodiment, a surface detection mechanism is a switch such as a film switch. In an embodiment, surface detection mechanism 325 is film switch 350 of FIG. 3b. However, surface detection mechanism 325 may be any type of mechanism, which is capable of detecting a surface such as writing surface 114 of FIG. 1. In an embodiment, a surface detection mechanism is capable of switching on a light source such as light source 320 when the apparatus makes contact with a writing surface. Further, in an embodiment, a surface detection mechanism is capable of switching off a light source when the apparatus does not make contact with the writing surface.

In an embodiment, the surface detection mechanism is capable of activating the light source when an apparatus makes contact with a surface such as writing surface 114 of FIG. 1. Further, in an embodiment, the surface detection mechanism is capable of deactivating the light source when the apparatus is not in contact with a surface. A surface detection mechanism may detect whether apparatus 300 is making contact with the writing surface 114 of FIG. 1 in any manner.

In an embodiment, apparatus 300 is similar to apparatus 200 of FIG. 2. In an embodiment, apparatus 300 is similar to apparatus 110 of FIG. 1.

FIG. 3b is a sectional diagram of a film switch 350 according to an example embodiment of the invention. In an embodiment, a film switch such as film switch 350 comprises thin films such as thin films 360a and 360b, which include two opposite inner surfaces 362a and 362b. In an embodiment, the film switch includes at least one pair of touch portions, such as touch portions 352 and 354, which are disposed on the two opposite inner surfaces 362a and 362b of the thin films 360a and 360b. In an embodiment, film switch 350 further includes an insulating layer 365 disposed between the thin films 360a and 360b. In an embodiment, the insulating layer 365 has at least one hole 368 to accommodate the touching of each pair of touch portions. In an embodiment, touch portions 352 and 354 switch to a conducting state when receiving press action, such as when a user presses apparatus 200 of FIG. 2 against a writing surface. In an embodiment, when touch portions 352 and 354 enter a conducting state, a signal is sent to a light source such as light source 220 of FIG. 2 causing light source 320 to illuminate. In an embodiment, film switch 350 is film switch 325 of FIG. 3a. In another embodiment, film switch 350 is film switch 225 of FIG. 2.

FIG. 4 is a diagram of an apparatus 400 having a circular body portion 430 according to an example embodiment of the invention. In an embodiment, apparatus 400 comprises a circular body portion 430, which is capable of being worn on a user's finger. In an embodiment, a finger is a finger or a thumb. In an embodiment, apparatus 400 further comprises a dome housing such as dome housing 415 coupled with circular body portion 430. In an embodiment, apparatus 400 further comprises a light source such as light source 420 coupled with circular body portion 430 and housed within the dome housing. In an embodiment, light source 420 is a light emitting diode. However, light source 420 may be any type of light source, which is capable of emitting light to an external receiver such as digital camera 122 on electronic device 120 both of FIG. 1. In an embodiment, light source 420 is coupled with a light source holder 433.

Apparatus 400 further comprises a battery such as battery 435 for powering the light source. In an embodiment, battery 435 is housed in an interior chamber such as interior chamber 437 of apparatus 400. In an embodiment, light source 420 is electrically coupled with a battery 435 and surface detection mechanism 425 with wires such as wires 450. However, any conducting material may connect light source 420 with battery 435 and surface detection mechanism 425.

In an embodiment, a surface detection mechanism such as surface detection mechanism 425 is coupled with circular body portion 430. In an embodiment, a surface detection mechanism is a switch such as a film switch. In an embodiment, surface detection mechanism 425 is film switch 350 of FIG. 3b. However, surface detection mechanism 325 may be any type of mechanism, which is capable of detecting a surface such as writing surface 114 of FIG. 1. In an embodiment, the surface detection mechanism 425 is capable of activating the light source when an apparatus is in contact with a surface such as writing surface 114 of FIG. 1. Further, in an embodiment, the surface detection mechanism 425 is capable of deactivating the light source when the apparatus is not in contact with a surface. A surface detection mechanism may detect whether apparatus 400 is making contact with the writing surface 114 of FIG. 1 in any manner. In an embodiment, apparatus 400 is apparatus 110 of FIG. 1.

In an embodiment, apparatus 400 further comprises a switch such as switch 440 coupled with circular body portion 430. Switch 440 may be any type of switch including but not limited to a toggle switch. Further, in an embodiment, switch 440 is electrically coupled with battery 435, light source 420 and surface detection mechanism 425. In an embodiment, switch 440 is configured to cause light source 420 to emit a particular color of light when switch 440 is in a particular position and apparatus 400 makes contact with a writing surface. In an embodiment, light source 420 is a multicolored light emitting diode configured to emit a different color for each position of switch 440 when apparatus 400 makes contact with a writing surface.

FIG. 5 is a diagram of an apparatus having a plurality of circular body portions according to an example embodiment of the invention. In an embodiment, apparatus 500 comprises two circular body portions 530 and 531 each coupled with the other by a coupling member such as coupling member 550. In an embodiment, coupling member 550 is any device which is capable of coupling the circular body portions together. In an embodiment, the coupling member is a resilient member such as a spring. In another embodiment, the coupling member is rigid. In an embodiment, the circular body portions are each capable of being worn on a user's finger. In an embodiment, a finger is a finger or a thumb.

In an embodiment, apparatus 500 further comprises a dome housing such as dome housing 515 coupled with a circular body portion such as circular body portion 530. In an embodiment, the dome housing may be coupled with any of the circular body portions. In an embodiment, apparatus 500 further comprises a light source such as light source 520 coupled with a circular body portion such as circular body portion 530 and housed within the dome housing. In an embodiment, light source 520 is a light emitting diode. However, light source 520 may be any type of light source, which is capable of emitting light to an external receiver such as digital camera 122 on electronic device 120 both of FIG. 1. In an embodiment, light source 520 is coupled with a light source holder 533.

Apparatus 500 further comprises a battery such as battery 535 for powering the light source. In an embodiment, battery 535 is housed in an interior chamber in either of circular body portions 530 or 531. In an embodiment, light source 520 is electrically coupled with battery 535 and at least one surface detection mechanism such as surface detection mechanisms 525 and 526 with wires such as wires 552. However, any conducting material may connect light source 520 with battery 535 and the at least one surface detection mechanism.

In an embodiment, each of the at least one surface detection mechanism such as surface detection mechanisms 525 and 526 are coupled with a circular body portion. According to FIG. 5, surface detection mechanism 525 is coupled with circular body portion 530 and surface detection mechanism 526 is coupled with circular body portion 531. In an embodiment, a surface detection mechanism is a switch such as a film switch. In an embodiment, surface detection mechanisms 525 and 526 are film switches such as film switch 550 of FIG. 3b. However, surface detection mechanism 525 and 526 may be any type of mechanism, which is capable of detecting a writing surface such as writing surface 114 of FIG. 1. In an embodiment, a surface detection mechanism is capable of switching on a light source such as light source 520 when an apparatus makes contact with a writing surface. Further, in an embodiment, a surface detection mechanism is capable of switching off a light source when an apparatus does not make contact with the writing surface.

In an embodiment, surface detection mechanisms 525 and 526 are capable of activating the light source 520 when the apparatus is in contact with a surface such as writing surface 114 of FIG. 1. Further, in an embodiment, surface detection mechanisms 525 and 526 are capable of deactivating the light source when the apparatus is not in contact with a surface. Further, in an embodiment, surface detection mechanisms 525 and 526 are each capable of causing the light source 520 to display a different color when each of the surface detection mechanisms makes contact with a surface. A surface detection mechanism may detect whether apparatus 500 is making contact with the writing surface 114 of FIG. 1 in any manner. In an embodiment, apparatus 500 is similar to apparatus 110 of FIG. 1.

In an embodiment, apparatus 500 further comprises a switch such as switch 540 coupled with circular body portion 530 or 531. Switch 540 may be any type of switch including but not limited to a toggle switch. Further, in an embodiment, switch 540 is electrically coupled with battery 535, light source 520 and each surface detection mechanism. In an embodiment, switch 540 is configured to cause light source 520 to emit a particular color of light when switch 540 is in a particular position and surface detection mechanism 525 makes contact with a writing surface. Further, in an embodiment, switch 540 is configured to cause light source 520 to emit a particular color of light when switch 540 is in a particular position and surface detection mechanism 526 makes contact with a writing surface. In an embodiment, light source 520 is a multicolored light emitting diode configured to emit a different color of light for each position of switch 540.

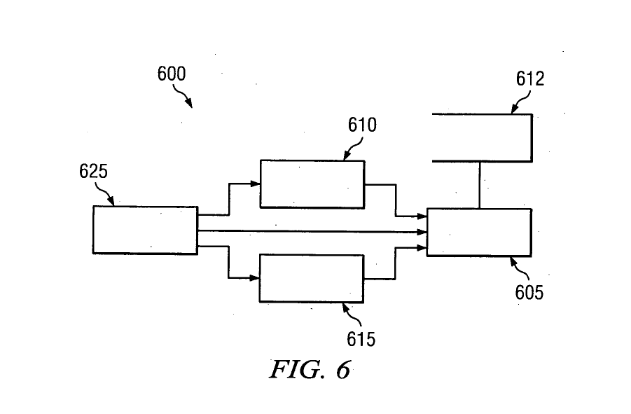

FIG. 6 is a block diagram of an apparatus 600 according to an example embodiment of the invention. In an embodiment, apparatus 600 comprises a battery 625; surface detection mechanisms 610 and 615; light source 605; and switch 612. In an embodiment, battery 625 is electrically coupled with surface detection mechanisms 610 and 615 and light source 605. Further, in an embodiment, surface detection mechanism 610 is electrically coupled with light source 605 and physically coupled with circular body portion 530 of FIG. 5. Further, in an embodiment, surface detection mechanism 615 is electrically coupled with light source 605 and physically coupled with a circular body portion 531 of FIG. 5. Further, in an embodiment, switch 612 is electrically coupled with light source 605.

In an embodiment, when a surface is detected by surface detection mechanism 610, surface detection mechanism 610 causes light source 605 to emit light in a particular color corresponding to a position of switch 612. Further, in an embodiment, when a surface is detected by surface detection mechanism 615, surface detection mechanism 615 causes light source 605 to emit light in a particular color corresponding to a position of switch 612. In an embodiment, apparatus 600 is apparatus 500.

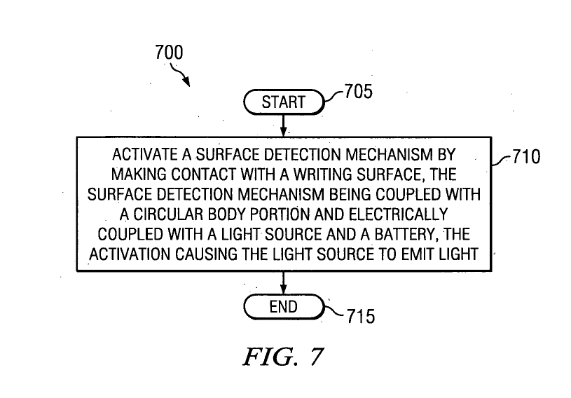

FIG. 7 is a flow diagram illustrating an example method 700 for providing user input according to an example embodiment of the invention. At 705, the method begins. In an embodiment at 710, a surface detection mechanism such as surface detection mechanism 525 of FIG. 5 is activated when an apparatus such as apparatus 400 of FIG. 4 contacts with a surface. Further, in an embodiment, the surface detection mechanism is coupled with a circular body portion such as circular body portion 430 of FIG. 4 and electrically coupled with a light source such as light source 520 of FIG. 5 and a battery such as battery 535. Further, in an embodiment, the light source is housed in a dome housing such as dome housing 415 of FIG. 4. Further, the activation of the surface detection mechanism causes a light source such as light source 520 to emit light.

Light such as the light 116 as depicted in FIG. 1 is received by a digital camera such as digital camera 122 on electronic device 120 of FIG. 1. In an embodiment, image processing technology embedded within electronic device 120 of FIG. 1 detects light from the light source and tracks movement of the dome housing along a writing surface. Further, in an embodiment, image processing technology embedded within electronic device 120 of FIG. 1 is capable differentiating among a plurality of colors emitted by a light source. In an embodiment, gesture recognition technology embedded within electronic device 120 of FIG. 1 determines particular gestures performed by an apparatus. In an embodiment, based on particular gestures as determined by the embedded gesture recognition technology and/or the at least one color of light emitted by a light source, electronic device 120 of FIG. 1 performs a function such as displaying a representation of the gesture on a display, tracking a cursor on a display, activating a feature on the electronic device 120 and/or the like.

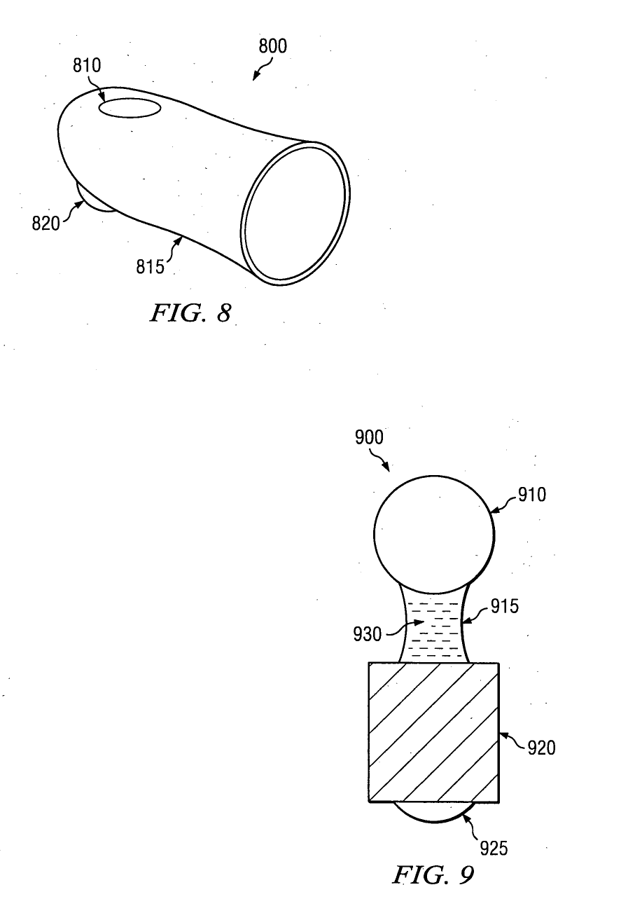

FIG. 8 is a diagram of an apparatus 800 comprising a finger sleeve 815 according to an example embodiment of the invention. In an embodiment, a finger sleeve configured to be worn on a finger of a user. In an embodiment, apparatus 800 further comprises a surface detection mechanism such as surface detection mechanism 820. In an embodiment, a surface detection mechanism is the surface detection mechanism 350 of FIG. 3b.

In an embodiment, apparatus 800 further comprises a colorable member such as colorable member 810 capable of displaying at least one color including but not limited to red, blue and green in response to a surface detection mechanism being activated. In an embodiment, colorable member 810 is a colorable film and/or the like. In an embodiment, colorable member 810 covers a portion of the finger tip as shown in FIG. 8. In another embodiment, colorable member substantially covers the fingertip. Further, in an embodiment, colorable member 810 is coupled with a surface detection mechanism and a battery (not shown) such as battery 337 of FIG. 3a, which powers colorable member 810. In an embodiment, colorable member 810 is a light source such as light source 320 capable of emitting light of at least one color.

In an embodiment, image processing technology embedded within electronic device 120 of FIG. 1 detects and tracks movement of a user's finger, which wears finger sleeve 815. Further, in an embodiment, image processing technology embedded within electronic device 120 of FIG. 1 is capable differentiating among a plurality of colors emitted by colorable member 810. In an embodiment, gesture recognition technology embedded within electronic device 120 of FIG. 1 determines particular gestures performed by the finger, which wears finger sleeve 815. In an embodiment, based on particular gestures as determined by the embedded gesture recognition technology and/or the at least one color of light emitted by colorable member 810, electronic device 120 of FIG. 1 performs a function such as displaying a representation of the gesture on a display, tracking a cursor on a display, activating a feature on the electronic device 120 and/or the like.

FIG. 9 is a diagram of an apparatus 900 comprising a hollow transparent dome housing 910 according to an embodiment of the invention. In an embodiment, apparatus 900 further comprises a base 920 and a neck 915, which is coupled with the hollow transparent dome housing 910 and base 920. In an embodiment, apparatus 900 further comprises a colored material such as colored material 930 housed within neck 915. In an embodiment, colored material 930 is a hyper-elastic plastic and/or the like. However, colored material 930 may be any material capable of being transferred between dome housing 910 and the neck 915 and/or base 920.

In an embodiment, apparatus 900 further comprises a surface detection mechanism such as surface detection mechanism 925. In an embodiment, surface detection mechanism 925 is surface detection mechanism 350 of FIG. 3b. However, surface detection mechanism may be any type of switch such as but not limited to a button.

In an embodiment, colored material 930 is housed in at least one of the base 920 and the neck 915. In an embodiment, apparatus 900 further comprises a material transferring component (not shown) embedded within base 920.

In an embodiment, the material transferring component is an injector powered by a power source such as a battery. In an embodiment, the material transferring component is coupled with a battery such as battery 337 of FIG. 3a and surface detection mechanism 925. In an embodiment, battery 337 provides power to the material transferring component.

In another embodiment, the material transfer component is a mechanical injector, which is capable of transferring colored material 930 using a force from a button press such as when a user activates surface detection mechanism 925. For example, if surface detection mechanism 925 is a button, a force of the button press provided by a user may push colored material 930 into dome housing 910. Further, for example, a release of the button may cause colored material 930 to be suctioned back into at least one of the base 920 and neck 915.

In an embodiment, the material transferring component is capable of transferring colored material 930 from at least one of the neck 915 and the base 920 to the dome housing 910 when surface detection mechanism is activated. In an embodiment, if a surface detection mechanism is a button, the surface detection mechanism is activated when the button is pressed by a user. Further, the material transferring component is capable of transferring colored material 930 from the dome housing 910 to at least one of the neck and the base 920 when surface detection mechanism is deactivated. In an embodiment, if a surface detection mechanism is a button, the surface detection mechanism is deactivated when the button released by a user.

In an embodiment, a surface detection mechanism is activated when a surface detection mechanism contacts a surface such as surface 114 of FIG. 1. In an embodiment, a surface detection mechanism is deactivated when surface detection mechanism does not make contact with a surface.

In an embodiment, image processing technology embedded within electronic device 120 of FIG. 1 detects and tracks movement of the dome housing 910. In an embodiment, gesture recognition technology embedded within electronic device 120 of FIG. 1 determines particular gestures performed by an apparatus 900. In an embodiment, based on particular gestures as determined by the embedded gesture recognition technology, the electronic device 120 of FIG. 1 performs a function such as displaying a representation of the gesture on a display, tracking a cursor on a display, activating a feature on the electronic device 120 and/or the like.

In an embodiment, apparatus 900 has an elongated configuration such as apparatus 200 of FIG. 2. In another embodiment, apparatus 900 has a circular configuration such as apparatus 400 of FIG. 400. In another embodiment, apparatus has a circular configuration such as apparatus 500 of FIG. 5.

Without in any way limiting the scope, interpretation, or application of the claims appearing below, a technical effect of one or more of the example embodiments disclosed herein is to provide a stable and reliable tracking device such as apparatus 400 of FIG. 4 for image processing technology such as an image processing technology embedded within electronic device 120 of FIG. 1. Another technical effect of one or more of the example embodiments disclosed herein is to provide an apparatus such as apparatus 500 of FIG. 5, which comprises a light source that keeps a consistent image profile while being used by a user from the point of view of image processing technology.

Embodiments of the present invention may be implemented in software, hardware, application logic or a combination of software, hardware and application logic. The software, application logic and/or hardware may reside on at least one of an apparatus such as apparatus 400 of FIG. 4 and an electronic device such as electronic device 120 of FIG. 1. If desired, part of the software, application logic and/or hardware may reside on an apparatus such as apparatus 500 of FIG. 5 and part of the software, application logic and/or hardware may reside on an electronic device such as electronic device 120 of FIG. 1. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 1. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus, comprising:
an elongated body portion having an interior chamber and a tapered end;
a transparent dome housing accommodated by said tapered end;
a light source housed within said transparent dome housing and capable of emitting light through said transparent dome housing to an external receiver;
a battery housed within said interior chamber and electrically coupled with said light source; and
a surface detection mechanism coupled with said transparent dome housing and electrically coupled with said light source and said battery, said surface detection mechanism capable of at least one of activating said light source when said apparatus contacts a surface and deactivating said light source when said apparatus does not contact said surface.

2. An apparatus according to claim 1, wherein said surface detection mechanism comprises at least one of a switch and a film switch.

3. An apparatus according to claim 1, further comprising a switch coupled with said elongated body portion and electrically coupled with said battery and said light source, said switch being capable of selecting a color of said light emitted by said light source.

4. An apparatus according to claim 1, wherein said light source is a light emitting diode.

5. An apparatus according to claim 1, wherein said apparatus is a computer mouse.

6. An apparatus according to claim 1, wherein said light is substantially at least one of red, green and blue.

7. An apparatus, comprising:
a circular body portion having an interior chamber;
a light source coupled with said circular body portion capable of emitting light to an external receiver;
a transparent dome housing coupled with said circular body portion, wherein said light source is housed within said transparent dome housing and said light source being capable of emitting light through said transparent dome housing to an external receiver.
a battery housed within said interior chamber and electrically coupled with said light source; and
a surface detection mechanism coupled with said circular body portion and electrically coupled with said light source and said battery, said surface detection mechanism capable of at least one of activating said light source when said apparatus contacts a surface and deactivating said light source when said apparatus does not contact said surface.

8. An apparatus according to claim 7, wherein said circular body portion is capable of being worn on a user's finger.

9. An apparatus according to claim 7, wherein said surface detection mechanism comprises at least one of a switch and a film switch.

10. An apparatus according to claim 7, further comprising a switch coupled with said circular body portion and electrically coupled with said battery and said light source, said switch being capable of selecting a color of said light emitted by said light source.

11. An apparatus according to claim 7, wherein said light source is a light emitting diode.

12. An apparatus according to claim 1, wherein said apparatus is a computer mouse.

13. An apparatus according to claim 1, wherein said light is substantially at least one of red, green and blue.

14. An apparatus, comprising:
a first and second circular body portions having at least one interior chamber;
a light source coupled with at least one of said first and second circular body portions capable of emitting light to an external receiver;
a transparent dome housing coupled with at least one of said first and second circular body portions, wherein said light source is housed within said transparent dome housing and said light source being capable of emitting light through said transparent dome housing to an external receiver;
a battery housed within said interior chamber and electrically coupled with said light source; and
at least one surface detection mechanism coupled with at least one of said first and second circular body portions and electrically coupled with said light source and said battery, said at least one surface detection mechanism capable of at least one of activating said light source when said apparatus contacts a surface and deactivating said light source when said apparatus does not contact said surface.

15. An apparatus according to claim 14, wherein at least one of said first and second circular body portions is capable of being worn on a user's finger.

16. An apparatus according to claim 14, wherein said surface detection mechanism comprises at least one of a switch and a film switch.

17. An apparatus according to claim 14, further comprising a switch coupled with at least one of said first and second circular body portions and electrically coupled with said battery and said light source, said switch being capable of selecting a color of said light emitted by said light source.

18. An apparatus according to claim 14, wherein said light source is a light emitting diode.

19. An apparatus according to claim 14, wherein said apparatus is a computer mouse.

20. An apparatus according to claim 1, wherein said light is substantially at least one of red, green and blue.

21. A method, comprising:
activating a surface detection mechanism by making contact with a writing surface, said surface detection mechanism being coupled with a circular body portion and electrically coupled with a light source and a battery, said activation causing said light source to emit light.
